(19) United States
(12) Patent Application Publication
(10) Pub. No.: US 2011/0255999 A1
(43) Pub. Date: Oct. 20, 2011

(54) USE OF A ROLLING-ELEMENT BEARING FOR BEARING ROTATING COMPONENTS IN VACUUM DEVICES AND VACUUM DEVICE

(75) Inventors: Ralf Adamietz, Wermelskirchen (DE); Petra Adamietz, Wermelskirchen (DE); Rainer Hoelzer, Huerth (DE); Markus Henry, Koeln (DE)

(73) Assignee: OERLIKON LEYBOLD VACUUM GMBH, Koeln (DE)

(21) Appl. No.: 13/057,320

(22) PCT Filed: Jul. 17, 2009
(86) PCT No.: PCT/EP2009/059245

§ 371 Date: Apr. 15, 2011

(30) Foreign Application Priority Data
Aug. 6, 2008 (DE) 10 2008 036 623.4

(51) Int. Cl. E21B 43/12; F16C 33/76

(52) U.S. Cl. 417/65; 384/477

(57) ABSTRACT

A rolling-element bearing for bearing rotating components in vacuum devices includes a plurality of rolling elements (10) arranged between bearing elements (12, 14). A bearing compartment (26) is for example closed by sealing elements (22, 24) on both sides. The sealing elements (22, 24) have a minor sealing gap(s). The rolling-elements bearing is used in vacuum sections in which a pressure of less than 10⁻³ mbar prevails.

The invention refers to the use of a rolling-element bearing for bearing rotating components in vacuum devices and to such a vacuum device.

Vacuum devices, such as vacuum pumps, comprise pumping elements arranged in the suction chamber. The pumping elements are Roots-type pistons, screw rotors and the like, for instance. Usually, the pumping elements are each supported by a rotating shaft. Each shaft is usually supported by two bearing arrangements. The bearing arrangements often include fat-lubricated rolling-element bearings. The use of optional rolling-element bearings in vacuum pumps is useful only in applications where the pressure does not fall below 10⁻³ mbar.

The rotating components, in particular the rotor shaft, are thus generally supported by fat-lubricated rolling-element bearings. According to the prevalent experts' opinion, it is necessary in this context to arrange the rolling-bearing elements such that they are not exposed to any high vacuum. Presently used rolling-element bearings are approved only for pressures up to 10⁻³ mbar. With lower pressures below 10⁻³ mbar, there is a risk that the large quantities of lubricant are drawn from the bearing space in which the rolling elements are housed, so that the service life of the bearing is shortened drastically. To enable the use of fat-lubricated rolling-element bearings, these must be arranged in an area where no excessive vacuum prevails. This often requires elaborate structures. For instance, the pump rotors of turbomolecular pumps are arranged on overhung shafts to allow for an arrangement of the rolling-element bearing in an area in which sufficiently high pressure prevails. The free cantilevered arm of the shaft, due to the overhung bearing, results in a restricted structural length of the shafts and further gives rise to substantial loads on the bearings. Moreover, such structures are expensive and elaborate.

It is another possibility to provide magnetic bearings instead of fat-lubricated bearings. However, magnetic bearings are expensive components which, in addition, have to be combined with safety bearings so as to guarantee emergency operation properties in case of failure.

It is an object of the invention to simplify the structure of vacuum devices that are also usable at rather low pressures of in particular less that 10⁻³ mbar.

The object is achieved, according to the invention, with the features of claims 1 and 15, respectively.

Studies have shown that rolling-element bearings with suitably designed sealing elements can also be used in vacuum sections where pressures prevail that are lower than 10⁻³ mbar, in particular lower than 10⁻⁵ mbar, and even lower than 10⁻⁷ mbar. Thus, it has been found surprisingly that, contrary to the prevalent experts' opinion and also to the manufacturer specifications regarding corresponding fat-lubricated rolling-element bearings, such rolling-element bearings cam also be used in low-pressure areas. Corresponding considerations have yielded that an undiminished service life of a bearing can be obtained also with pressures lower than 10⁻³ mbar.

The rolling-element bearing used according to the invention comprises two bearing elements between which the rolling elements are arranged in the bearing space. The bearing elements may be an inner and an outer bearing race, for instance. Likewise, one of the bearing races can be omitted and be formed directly by the shaft itself or by the housing surrounding the shaft, so that one of the two bearing elements is enclosed by the shaft or a component surrounding the shaft, such as a housing. Further, at least one sealing element is provided that seals the bearing space on at least one side against a vacuum section. The bearing space, in which the rolling elements and the lubricant are accommodated, is separated from the vacuum section by the sealing element, which is in particular substantially annular in shape. In order to prevent or drastically reduce the especially fatty lubricant from escaping or being drawn into the vacuum section even at low pressures in the vacuum section, the invention provides that the sealing element forms a gap ring, with the sealing element being arranged at a distance from one of the two bearing elements such that a particularly small gap width exists. Further, the sealing element is firmly connected to the other bearing element, either indirectly or directly.

If the bearing element is an outer bearing race, for instance, the sealing element can be firmly connected directly to the bearing race or also to a component such as a housing that holds the bearing race. If the, for instance, outer bearing race is stationary, the sealing element is also mounted to be stationary. In order to allow low pressures in the vacuum section, in particular pressures lower than 10⁻³ mbar, without too large quantities of lubricant being drawn from the bearing, the distance between the sealing element and one of the two bearing elements, i.e. the gap width, is smaller than the mean free path of the molecules in the vacuum section. Preferably, the mean free path of the molecules of air at a temperature of 20° C. is assumed.

Preferably, the following applies to the gap width s:

$$s < \frac{x \cdot {10}^{- 5} m mbar}{p}$$

where p is the pressure in the vacuum section in mbar, and the sealing element is provided between the corresponding vacuum section and the bearing space. Here,

xεR,
where 0.5≦x≦12
   x can be specified for any gas within the interval from 0.5 to 12.

In a preferred embodiment, the gap width or the distance s is less than 20%, especially less than 10%, and particularly preferred less than 5% of a bearing element distance h. In this context, the bearing element distance h refers to the distance between the two bearing elements or the lateral free distance, i.e. the lateral opening of the bearing. It is particularly preferred that both the above formula for the gap width as a function of pressure and the condition for the gap width as a function of the bearing element distance are met.

In a preferred embodiment, two mutually opposite sealing elements are provided to seal the bearing space on both sides. Possibly, the two sealing elements can be of different designs, especially of different gap widths, i.e. the respective distance to the corresponding bearing element may differ. The reason is that the pressure on the two bearing elements can differ and that, for instance, a sealing element with a larger gap width may be sufficient on one of the two sides. Thereby, manufacturing costs can be cut.

In a preferred embodiment the at least one sealing element is fixedly connected to the outer bearing element. As a result, the sealing gap is formed between the inner bearing element, which may also be the rotating component itself, for example, and the sealing element. Thereby, the length of the sealing gap is maintained as short as possible. This is advantageous in that the surface, via which lubricant can escape, is reduced. Thus, it may be suitable for a rolling-element bearing with an inner bearing element, such as a bearing race, to configure the sealing element such that it is passed over the inner bearing race and the effective gap width is formed between the sealing element and the shaft. Thus, a short gap length can be realized also with bearings having an inner race. It is an essential inventive aspect of this embodiment that the distance is short between the sealing element and one of the two bearing elements or a component connected to this bearing element. Corresponding to the structure chosen, the sealing gap, which according to the invention is narrow and which allows for low pressures in the adjacent vacuum section, is thus provided immediately between the sealing element and the bearing element or between the sealing element and the component connected to the corresponding bearing element, such as the rotating shaft.

The distance is preferably constant in the circumferential direction, so that the gap is a ring of constant width.

It is preferred to make the bearing space, which houses the rolling elements and the lubricant, as small as possible. The shape of the sealing elements can thus be chosen such that their distance from the rolling elements or a cage supporting the rolling elements is small.

According to the invention, the rolling-element bearing is used in a speed range of more than 6,000 rpm, especially more than 30,000 rpm. In this context, the inventive design of the bearing employed has the advantage that, despite the very high speeds, the corresponding bearing can be used with very low pressures.

In particular, it is advantageous to use the above described bearing with fastrotating shafts such as they are provided in turbomolecular pumps. Specifically, the above described rolling-element bearings serve to support the rotor shaft of turbomolecular pumps, with the bearing being used in particular on the suction side, i.e. the side where high vacuum prevails.

Further, it is particularly preferred to use suitable lubricants within the bearing space. Specifically, a lubricant is a compound formed by a lubricating agent and a thickener. In this context, the lubricating agent especially comprises oil or is oleaginous. Here, oil is not only understood to comprise mineral or natural oil, but also a lubricating agent which, in the application area, has a liquid, microscopically visible aggregate state. Preferably, the lubricant is pasty, which in the present case means that upon application of small shear stresses, ductile deformations of the outer shape are possible, with the outer shape being changed by those stresses and not by its own weight or by gravitational acceleration.

The invention further refers to a vacuum device, in particular a vacuum pump, comprising a rolling-element bearing of the above described type, especially in the preferred embodiments described, with the rolling-element bearing being arranged in a vacuum section where pressures of less than 10⁻³ mbar are allowable. This means that even if pressures of less than 10⁻³ mbar occur, the duration of the bearing service life in this section can be expected to remain unchanged with respect to an operation at other pressures.

The vacuum pump comprises pumping elements arranged in a suction chamber, such as Roots-type pistons, screw rotors and the like. Generally, the pumping elements are each connected to a rotating shaft supported by at least two bearing arrangements. According to the invention, one of the two bearing arrangements can be arranged in a vacuum section where a correspondingly low pressure prevails.

In a preferred embodiment the vacuum device of the present invention specifically comprises a preferred embodiment of the above described rolling-element bearing.

The rolling-element bearing represents a further independent invention, in particular in the above described preferred embodiments.

The following is a detailed description of the invention with reference to preferred embodiments and to the drawings.

In the Figures:

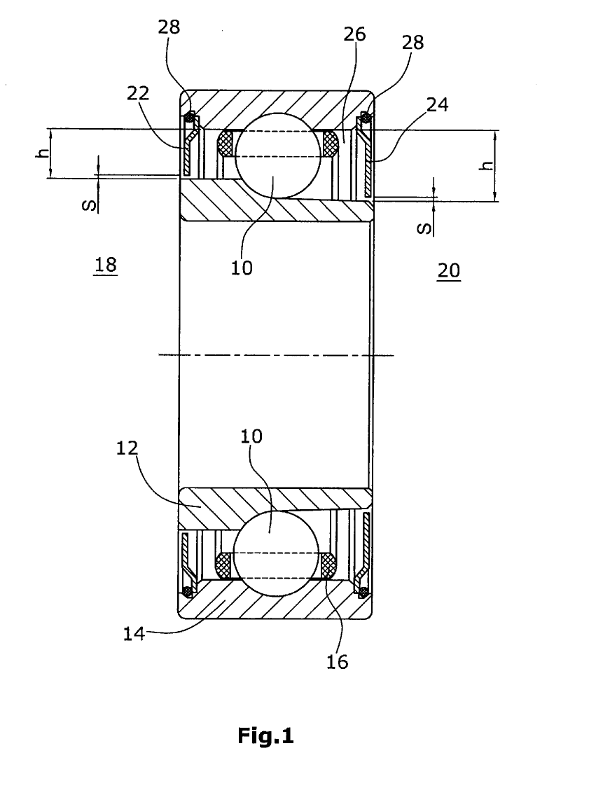

FIG. 1 shows a schematic section through a first embodiment of a rolling-element bearing suited for use according to the invention,

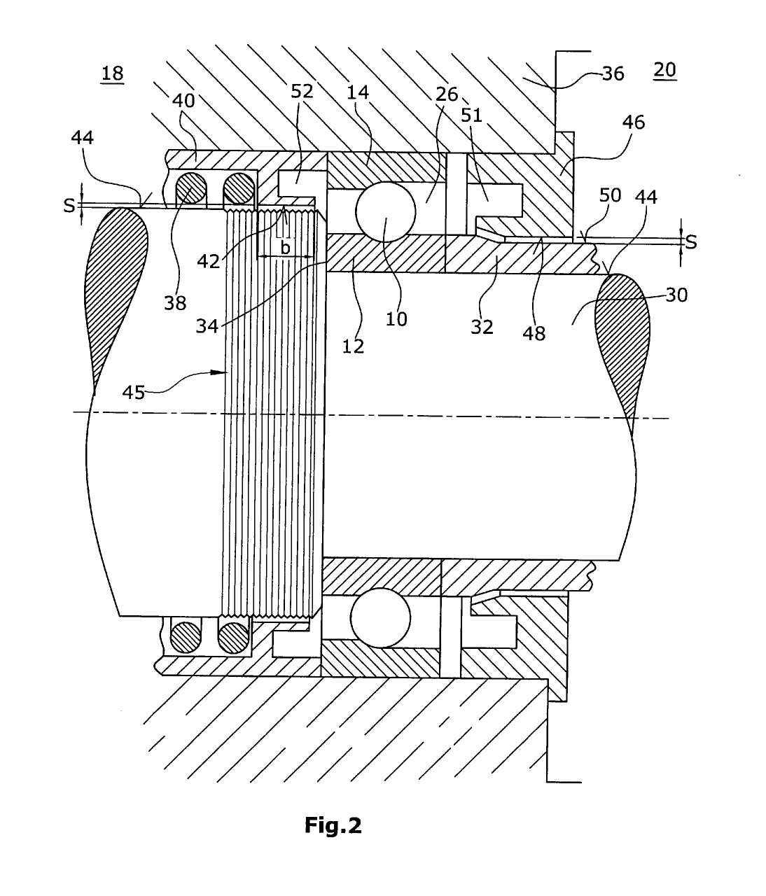

FIG. 2 shows a schematic section through a second embodiment of a rolling-element bearing suited for use according to the invention, and

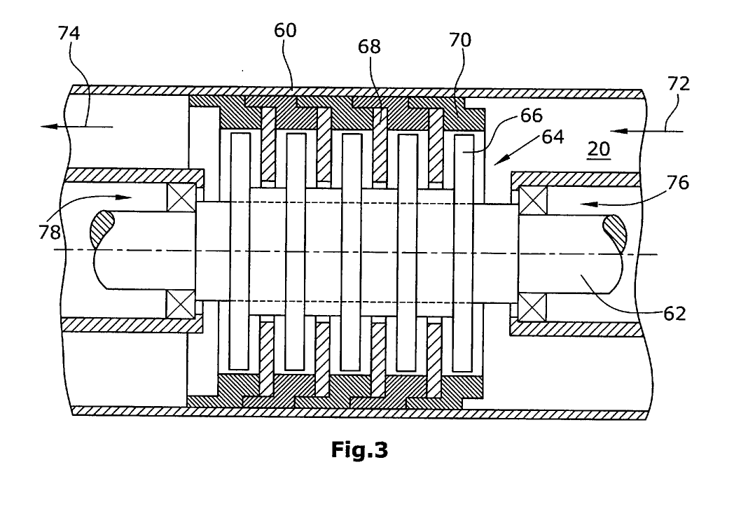

FIG. 3 shows a schematic, greatly simplified section through a turbomolecular vacuum pump with a rolling-element bearing arranged in a low-pressure section.

In the first embodiment of a rolling-element bearing, illustrated in FIG. 1, the rolling elements 10 in he form of balls are arranged between an inner bearing element or bearing race 12 and an outer bearing element or bearing race 14. The rolling elements 10 are held by a cage 16. On both sides 18, 20, which respectively define a vacuum section, a respective sealing element 22, 24 is arranged. The two sealing elements 22, 24 define a bearing space 26 between them, which bearing space houses the rolling elements 10 and is filled a lubricant, such as fat. The two sealing elements 22, 24, which are of a cranked shape in the embodiment illustrated, are fixedly connected to the outer bearing race by means of retaining elements, such as safety rings 28.

The sealing elements are designed such that they have a distance s to the inner bearing race 12, wherein the gap width or the distance s of the sealing element 22 and the sealing element 24 can differ from each other. This depends on the use of the present rolling-element bearing and the pressure prevailing in the two vacuum sections 18, 20. Preferably, the gap width s is smaller than the mean free path of the molecules of the vacuum surrounding the rolling-element bearing or the vacuum prevailing in the vacuum sections 18, 20. According to the invention, the same may be lower than 10⁻³ mbar. The illustrated embodiment of the rolling-element bearing shows different bearing element distances h on both sides, due to the asymmetric design of the inner bearing race 12. Here, the bearing element distance h is the free distance between the two bearing elements or bearing races 12, 14.

In the second embodiment illustrated in FIG. 2, similar or identical components are identified by the same reference numerals.

In this embodiment (FIG. 2), the inner bearing race 12 is arranged on a shaft 30 and is pressed against a bearing shoulder 34 by a retaining element 32 so as to fix the race. The outer bearing race 14 is provided in a housing element 36 and is fixed, for instance, by means of a retaining member 40 biased by a spring 38. The retaining member 40 is connected to the housing 36 in a manner corresponding to the outer bearing racing 14. The retaining member 40 thus further serves as a sealing element and therefore, according to the invention, has a distance s between an inner side 42 facing towards the shaft 30 and an upper side 44 of the shaft 30. The sealing gap s in turn has the narrow width, as provided by the invention, which is a function of the pressure prevailing in the vacuum section 18. In the embodiment illustrated, the bearing space 26 further includes storage spaces 51, 52 provided in the sealing elements 40 and 46, which also hold lubricant.

On the opposite side of the bearing, facing to the vacuum section 20, a component 46 is also fixedly connected to the housing 36 to serve as a sealing element. According to the invention, an inner surface 48 of the sealing element 46, facing towards the shaft 30, has a small distance s to the upper side 50 of the retaining element 32. It is also possible to make the retaining element 32 shorter in the region of the sealing gap s, so that the sealing gap s is formed immediately between the surface 48 of the sealing element 46 and the upper side 44 of the shaft 30.

As illustrated by the retaining member 40 in FIG. 2, the inner side 42 directed to the shaft 30 has a width b. The larger the width b is, the better is the sealing effect of the gap. The width b is at least s. The same is true for the gap widths of other sealing element designs, such as the sealing elements 22, 24 and 46, for instance.

In the interest of a further reduction of lubricant loss from the bearing space 26 or to allow for the selection of a larger gap width, a thread 45 can be provided on the upper side 44 of the shaft 30, the thread acting as an active conveyor element. The thread 45 conveys lubricant molecules deposited on the shaft 30 back towards the bearing space 26. In addition to or instead of the thread 45, a corresponding thread can be provided on the opposite side, i.e. on the inner side 42. The thread must only have a lower depth so that helical indentations will be sufficient as an active conveyor element. Even turning grooves formed when the shaft 30 is turned on a lathe act as an active conveyor element. It should be taken into account that the helical indentations extend helically towards the bearing space 26 so that conveying takes place towards the bearing space 26.

As can be seen in particular from the embodiment illustrated in FIG. 2, it is essential to the invention that the bearing space 26, which houses the rolling elements 10 and the lubricant, comprises but a little connection to one or both vacuum sections 18, 22, which is in the form of the narrow sealing gap s. Furthermore, it is essential that a sealing gap s is provided, so that the opposing parts rotating in opposite directions do not contact each other. This is of particular necessity because of the high rotational speeds.

According to the invention, the two preferred embodiments of rolling-element bearings or bearing arrangements, described above with reference to FIGS. 1 and 2, can be used in vacuum sections in which pressures prevail that preferably are lower than 10⁻³ mbar.

Analogous or similar bearings can be used in a turbomolecular pump, as schematically illustrated in FIG. 3. The turbomolecular pump schematically illustrated in FIG. 3 comprises a rotor shaft 62 in a pump housing 60. The rotor shaft 62 supports a rotor element 64 as a pumping element. The rotor element 64 has rotor discs 66 between which stator discs 68 are arranged. The stationary stator discs 68 are retained by stator rings 70.

The turbomolecular pump schematically illustrated in FIG. 3 draws a medium in the direction of an arrow 72 and ejects it in the direction of an arrow 74. On the right-hand side in FIG. 3, the suction side of the turbomolecular pump, a low pressure of preferably less than 10⁻³ mbar prevails. According to the invention, a bearing arrangement 76, which, for instance, may be a bearing described with reference to FIG. 1 or 2, is arranged in the vacuum section 20. On the left-hand side in FIG. 3, the shaft is supported by another bearing 78 which may possibly also be a rolling-element bearing of a simpler design.

1. Use of a rolling-element bearing for supporting rotating components in vacuum devices, comprising
a plurality of rolling elements arranged in a bearing space between two bearing elements, and
at least one sealing element which seals the bearing space on at least one side against a vacuum section, the sealing element being fixedly connected to one of the two bearing elements or to a component connected to said bearing element, and wherein, in order to form a gap ring seal, the sealing element is arranged at a distance s from the other bearing element or from a component connected to said bearing element, with the distance s being smaller than a mean free path of the molecules in the vacuum section,
wherein a pressure in the vacuum section is lower than 10⁻³ mbar.

2. The use according to claim 1, wherein the pressure in the vacuum section is lower than 10⁻⁵ mbar, in particular lower than 10⁻⁷ mbar.

3. The use according to claim 1, wherein the distance s is defined by:
$$s < \frac{x \cdot {10}^{- 5} m mbar}{p}$$
where p is the pressure in the vacuum section in mbar, and where
xεR,
where 0.5≦x≦12.

4. The use according to claim 1, wherein the distance s is less than 20%, preferably less than 10% and particularly preferred less than 5% of a bearing element distance.

5. The use according to claim 1, wherein the at least one sealing element includes two opposite sealing elements for sealing the bearing space on both sides.

6. The use according to claim 5, wherein both sealing elements have different distances s on each bearing side to compensate for different pressures prevailing in the vacuum sections.

7. The use according to claim 1, wherein said at least one sealing element is fixedly connected to the outer bearing element.

8. The use according to claim 1, wherein the distance s is constant in the circumferential direction.

9. The use according to claim 1, wherein, in order to form a small bearing space, said at least one sealing element has a small distance to the rolling elements or a cage supporting the rolling elements.

10. The use according to claim 1, wherein a width (b) of a sealing element in the area of the gap ring seal is at least as large as the distance s.

11. The use according to claim 1, further including:
an active conveyor element for returning escaped lubricant to the bearing space, said conveyor element being arranged in the area of the sealing element.

12. The use according to claim 11, wherein the active conveyor element comprises:
helical indentations in an inner side of the sealing element which faces toward a rotor shaft and/or in a surface of said rotor shaft in the region of the sealing element.

13. The use according to claim 1, wherein the rotating components supported by said at least one rolling-element bearing rotate at a speed of at least 6,000 rpm, in particular more than 30,000 rpm.

14. The use according to claim 1, wherein the use is implemented in a turbomolecular pump, in particular for the purpose of supporting the pump rotor.

15. A vacuum device, in particular a vacuum pump, comprising
pumping elements disposed in a suction chamber,
at least one rotating shaft supporting the pumping elements,
at least two bearing arrangements supporting the shaft, at least one of said bearing arrangements being a rolling-element bearing, comprising:
a plurality of rolling elements arranged in a bearing space between two bearing elements, and
at least one sealing element for sealing the bearing space on at least one side against a vacuum section,
wherein the sealing element is fixedly connected to one of the two bearing elements or to a component connected to said bearing element, and wherein, in order to form a gap ring seal, the sealing element is arranged at a distance s from the other bearing element or from a component connected to said bearing element, with the distance s being smaller than the mean free path of the molecules in the vacuum section,
wherein the pumping elements can draw a pressure in the vacuum section to less than 10⁻³ mbar.

16. The vacuum device of claim 15, wherein the distance s is defined by:
$$s < \frac{x \cdot {10}^{- 5} m mbar}{p}$$
where p is the pressure in the vacuum section in mbar, and where
xεR,
where 0.5≦x≦12.

17. A vacuum pump comprising:
a housing;
a rotor supported on a rotor shaft;
at least one rolling-element bearing according to claim 1 which rotatably supports the rotor shaft in the housing;
a stator supported by the housing such that the rotor and stator define the vacuum section thereadjacent and such that rotation of the rotor relative to the stator draws the pressure in the vacuum section lower than 10⁻³ mbar.

18. A rolling-element bearing for supporting rotating components in vacuum devices comprising:
a plurality of rolling-elements arranged in a bearing space between two bearing elements, and
at least one sealing element which seals the bearing space on at least one side against a vacuum section, the sealing element being fixedly connected to one of the two bearing elements or to a component connected to said bearing element, and wherein, in order to form a gap ring seal, the sealing element being arranged at a distance from the other bearing element or from a component connected to said bearing element, with the distance being smaller than the mean free path of the molecules in the vacuum section, wherein the pressure in the vacuum section is lower than 10⁻³ mbar.

19. The rolling-element bearing according to claim 18, wherein a width of a sealing element in the area of the gap ring seal is at least as large as the distance between the sealing element and the other bearing element.

20. The rolling-element bearing according to claim 18, wherein the distance is less than
$$\frac{x \cdot {10}^{- 5} m mbar}{p}$$
$$where$$
$$s < \frac{x \cdot {10}^{- 5} m mbar}{p}$$
where p is the pressure in the vacuum section in mbar, and where
xεR,
where 0.5≦x≦12.
